(19) United States
(12) Patent Application Publication
(10) Pub. No.: US 2025/0323032 A1
(43) Pub. Date: Oct. 16, 2025

(54) SATELLITE SYSTEM FOR REDUCING PLANETARY WARMING THROUGH SOLAR GAIN MITIGATION

(71) Applicant: Eric Jason Crews, Blacksburg, VA (US)

(72) Inventor: Eric Jason Crews, Blacksburg, VA (US)

(21) Appl. No.: 19/084,129

(22) Filed: Mar. 19, 2025

Related U.S. Application Data
(60) Provisional application No. 63/634,543, filed on Apr. 16, 2024.

(51) Int. Cl. H01J 49/14; A01G 15/00; B64G 1/24

(52) U.S. Cl. CPC H01J 49/147; A01G 15/00; B64G 1/242

(57) ABSTRACT

A satellite system designed to address planetary warming by reducing solar gain is disclosed. The system tackles the technical challenge of ineffective current methods in combating climate change. This technology employs transmitted resonance to decompose Carbon Dioxide and Sulfur Dioxide in the atmosphere, inducing lightning to vitrify sulfur compounds and sequester carbon. The primary application is to test climate mitigation strategies without harming Earth's atmosphere, with the satellite positioned in high day-side Venusian orbit to validate carbon sequestration. The system includes components such as electron emitters, particle accelerators, and inert gas pressure tanks. This approach offers a novel method for atmospheric repair and space debris management, potentially transforming Venus's atmosphere into a more stable state.

### CROSS REFERENCE TO RELATED APPLICATION

This application claims the benefit of priority of U.S. provisional application No. 63/634,543, filed Apr. 16, 2024, the contents of which are herein incorporated by reference.

### BACKGROUND OF THE SUBJECT DISCLOSURE

The present invention relates to the use of satellites for climate change, and more particularly, to a satellite for reducing planetary warming through solar gain.

Currently, there are no known systems for mitigating planetary warming. With increased industrialization and the subsequent burning of fossil fuels, Earth is warming at an alarming rate due to the increased presence of carbon dioxide in the atmosphere. Current methods focus on reducing the burning of fossil fuels, but with emerging economies and growing populations utilizing more resources, current methods are not effective. Planetary warming is responsible for rising see levels, more severe weather, famine and could eventually lead to species extinction. Furthermore, there are no mechanisms to effectively test destructive climate mitigations strategies and systems on Earth's atmosphere without potentially causing catastrophic damage.

As can be seen, there is a need for a system that reduces planetary warming, caused by solar gain and a mechanism for testing the system without harming Earth's atmosphere. The terraforming satellite design embodied in the subject disclosure uses transmitted resonance to decouple Carbon Dioxide and Sulfur Dioxide while electrically charging the atmosphere to induce Lightning causing vitrification of Sulfur compound to “ash out” the Sulfur while producing loose Oxygen and Loose Hydrogen to form water and High-Altitude Ozone.

SUMMARY OF THE SUBJECT DISCLOSURE

In one aspect of the present subject disclosure, a satellite system for reducing planetary warming through solar gain mitigation provides the following: a platform configured to support the system components; a transmitted resonance subsystem has a plurality of carbon dioxide resonance decomposition transmitters and a plurality of sulfur dioxide resonance transmitters arranged in a polar array, the transmitted resonance subsystem configured to decouple carbon dioxide and sulfur dioxide through vibratory separation and transmitted resonance; an atmospheric ionization subsystem includes at least one electron emitter arranged about 360° and configured to ionize atmospheric constituents and induce lightning to cause plasma destruction that vitrifies sulfur compounds while sequestering carbon; a positioning subsystem configured to place the satellite in a high day-side Venusian orbit to induce hemisphere ionization and facilitate vibratory separation of thermal retaining atmospheric constituents; and a control subsystem operatively connected to the transmitted resonance subsystem, the atmospheric ionization subsystem, and the positioning subsystem, the control subsystem configured to coordinate operation of the system components to reduce solar gain and thereby mitigate planetary warming.

In another aspect of the subject disclosure, the satellite system further provides wherein the platform has solar panels configured to provide electrical power to the system components, wherein the transmitted resonance subsystem further includes a hinged lid for protecting the carbon dioxide resonance decomposition transmitters, wherein the atmospheric ionization subsystem provides a plurality of electron emitters arranged in a ring configuration about the platform, wherein the positioning subsystem further includes a propulsion unit configured to maintain and adjust the satellite in the high day-side Venusian orbit, wherein the control subsystem further has a communication module configured to transmit telemetry data regarding system performance, wherein the transmitted resonance subsystem is configured to transmit pulsed resonance signals to induce vibratory separation of carbon dioxide and sulfur dioxide, wherein the atmospheric ionization subsystem is further configured to generate electrical discharges to induce lightning for plasma destruction that vitrifies sulfur compounds, wherein the platform includes a radiation-resistant hull constructed from materials configured to mitigate environmental damage, or wherein the control subsystem is programmed to coordinate periodic calibration and synchronization of the transmitted resonance subsystem and the atmospheric ionization subsystem.

In yet another aspect of the subject disclosure, a method for reducing planetary warming through solar gain mitigation includes the following steps: positioning a satellite in a high day-side Venusian orbit configured to induce hemisphere ionization; transmitting pulsed resonance signals from a polar array of carbon dioxide resonance decomposition transmitters and sulfur dioxide resonance transmitters arranged about the satellite to decouple carbon dioxide and sulfur dioxide through vibratory separation; ionizing the atmosphere by activating electron emitters arranged about 360° to induce lightning that causes plasma destruction wherein the induced lightning vitrifies sulfur compounds and sequesters carbon; and coordinating the positioning, transmission, and ionization steps via a control subsystem to reduce solar gain and thereby mitigate planetary warming.

In still yet another aspect of the subject disclosure, the method for reducing planetary warming through solar gain mitigation further includes, wherein the periodic calibration is configured to automatically initiate a diagnostic routine to verify the operational status of the carbon dioxide resonance decomposition transmitters and the sulfur dioxide resonance transmitters; further configuring a user interface to allow manual override and adjustment of the calibration and synchronization parameters of the transmitted resonance subsystem and the atmospheric ionization subsystem, wherein the periodic calibration further adjusting the transmission power levels of the pulsed resonance signals based on telemetry data received from the communication module, wherein the synchronization of the transmitted resonance subsystem and the atmospheric ionization subsystem includes coordinating the timing of the electron emitter activation with the initiation of the pulsed resonance signals to optimize vibratory separation, and/or wherein the control subsystem includes a processor configured to execute software instructions stored on a non-transitory computer-readable medium for performing the periodic calibration and synchronization of the transmitted resonance subsystem and the atmospheric ionization subsystem.

These and other features, aspects and advantages of the present subject disclosure will become better understood with reference to the following drawings, description and claims.

### BRIEF DESCRIPTION OF THE DRAWINGS

FIG. 1 is a side view of an exemplary embodiment of the subject disclosure, illustrating the satellite.

FIG. 2 is a schematic depiction of an exemplary embodiment of the subject disclosure, illustrating the main electricity generator system.

FIG. 3 is a schematic view of an exemplary embodiment of the subject disclosure, illustrating a main generator drive unit-a gas pressurized generator Argon.

FIG. 4 is the top and end views of exemplary embodiments of the subject disclosure, illustrating the satellite.

FIG. 5 are views of an exemplary embodiment of the subject disclosure, illustrating the outer hull mount electromagnetic levitation balls.

FIG. 6 is a schematic view of an exemplary embodiment of the subject disclosure, illustrating the internal spherical positional sealed Gas Jet Drives.

### DETAILED DESCRIPTION OF THE SUBJECT DISCLOSURE

The following detailed description is of the best currently contemplated modes of carrying out exemplary embodiments of the subject disclosure. The description is not to be taken in a limiting sense but is made merely for the purpose of illustrating the general principles of the subject disclosure, since the scope of the subject disclosure is best defined by the appended claims.

As stated above, current climate mitigation strategies focus on reduction of consumption of fossil fuels which subsequently would reduce the production of Carbon Dioxide, a major contributor to planetary warming.

Broadly, an embodiment of the present invention provides a satellite design that utilizes transmitted resonance while ionizing the atmosphere to cause plasma destruction yielding the vitrification of heavy Sulfur also producing Carbon ash. The Atmospheric Carbon sequestering the Carbon within the vitrification. Furthermore, the satellite is placed in high day side Venusian orbit to induce Hemisphere ionization inducing lightning and the vibratory separation of the thermal retaining Carbon Dioxide, to validate carbon sequestration without damaging Earth's atmosphere. Generated electricity can be re-introduced into the vessels functions to obtain required power levels for the connected system components to operate in their required function.

The systemic components of the subject disclosure include the following (where it should be noted that values provided in the list of components are approximations meaning they can vary by at least twenty percent plus or minus):
1. Electric servo, “positional servo” with dual electricity transfer through bore current transfer slip ring with positional sensor.
2. Spheric positional mobile ring positions by servo electric motor with positional sensors to control the ring position, mounts outer external encasement impact shield.
3. Spherical positional mobile mounting base mounts to the hexagonal hull and the particle accelerator rings-contain thru-bore current and information transference slip rings to control the electromagnets contained within the “flight ball”.
4. Levitation magnetics flight vector control electromagnetics.
5. Refrigeration refrigerant pressure tank.
6. Electromagnet control solenoid and hydraulic fluid system mount.
7. Sulfur Dioxide/Sulfuric Acid resonance decomposition emitter head contains sensor bank, camera, infrared, ultraviolet. Sulfur Dioxide resonance decomposition transmitter-transmits a pulsing vibration to wiggle apart the bond between Sulfur and the Oxygen molecule to cause through the ionization process a “recombined compound” then correcting the “thermal retention” and Ph (acidic), properties of the Sulfur Dioxide.
8. Hydraulic piston system for the Carbon Dioxide Resonance emitter lid.
9. Hinged hydraulic piston operates Carbon Dioxide Resonance emitter lid.
10. Carbon Dioxide resonance decomposition transmitter sum of six in 360 degrees left endpoint polar array
11. Sulfur Dioxide resonance transmitter sum of six in 360 degrees left endpoint polar array
12. Combine particle accelerator and electromagnetic toroid electromagnet vessel shielding system
13. Union mounting bolt plate assembly for both letter “A” and letter “C”
14. Inert Nobel gas (Argon) occupying ring pressure tanks used to fill or depressurize the “lift jets” letter “B” used for both letter “A” and letter “C”. Component hard bolts to the hull of the vessel
15. Electron emitter—sum of 6 about 360 degrees, used to induce lightning within the atmosphere of Venus which causes lightning-induced “plasma destruction” to increase the sequestration of Sulfur by means of vitrification also then forming high level Ozone (O3) via the Ultraviolet light produced by the lightning itself.
16. An electric motorized angular positional system for the electron emitter contains positional sensor and connection linkage.
17. Internal induction protection (protects from induced current or radiation) for the system electronic control circuits temperature maintained includes chilling system contains circuit-controlled avionics/helm control-flight controls servo robot accessible, electrical relay system, circuit breaker system for vessel systems
18. Oil jet mobile avionics trajectory vector unit also used to maintain orbital “static” while the vessel is in operation, with a sum of four total units in some embodiments.
19. Oil jet and mounting system
20. Frequency focus reflector bounces the transmitters signal
21. Landing gear hydraulic piston system
22. Landing gear leg beam
23. Landing gear foot positional hydraulic piston stabilizer
24. Landing gear foot positional hydraulic piston stabilizer
25. Landing gear pivot
26. Rubber landing gear foot tread—and electromagnet that hull contacts to a permanent magnet upon the hull's outer surface or used to stabilize and or the “grab” objects intended to re-enter
27. Particle accelerator and electron emitter unit contain 12 electron injectors that feed velocity to the electron emitters, number 15, to “sink” to low altitude to cause cloud-based lightning to arc to the surface of the ground of Venus. This is required to cause the ground to act as an electrical ground.
28. Internal servo robot arm maintenance services system—The unit can replace components with adjustments and do minor system functions adjustments using an inter change grip (multi tool), to then use multiple tool that are stowed number 29.
29. Multi tool stow
30. Servo robot accessible electronics bay redundancy avionics secondary electricity management control and Battery box—inductance cage shielded.
31. Vessel hydraulic fluid pumping system, servo robot accessible
32. Carbon Dioxide resonance focus diffuser to “spread” the diffused transmission wave to cover wide swaths of the atmosphere (total day side hemisphere)
33. “Lift jet” injection manifold—unit contains 8 main pressure rated channel
34. High speed travel electromagnetic locking electromagnet—when in high-speed transit the lonization transmitter power hinge tilts the transmitter to lock the transmitter and sensor bank to monitor active function/infrared/optical camera/spectrometer-sum of ten (each surface), about 360 degrees so that the landing gear can operate.
35. Brushless generator transonic impeller (mid speed of the vacuum system that causes negative “pressure” in the lower half of the “lift jet” engine system).
36. Brushless electric motor “compressor” transonic jet fan
37. High-speed brushless electric motor “compressor” transonic jet fan
38. Brushless generator transonic impeller causes increased mechanical speed in the compressor jet assembly, number 37
39. Ratio gear system sealed chilled lubricant (silicone oil) cause alignment to increase speed of the rotating compressor number 35 (gear system at 1:4)
40. Ratio gear system sealed chilled lubricant (silicone oil) cause alignment to increase speed of the rotating compressor number 35 (gear system at 1:4)
41. Electric and hydraulic fluid actuated “lift jet” throttle valve unit controls the Argon flow speed exiting the system compression venturi
42. Coil return tube—vacuum system causes low/negative pressure post “after” the Venturi tube returning the gas at lower pressure to the thrust chamber providing constant discharge pressure into vacuum causing vessel lift via sealed flow system; in some embodiments, a mechanical balloon.
43. Vacuum flow manifold
44. Electric drive motor for the base vacuum transonic electric compound hyper jet contains mechanical drive pneumatic impeller for mechanical running with 1:50 ratio gear system to advance the compression vacuum jet fan system in addition to the electric motor drive system. Air pressure (Nobel gas pressure) obtained from the safety regulator valve upon the “lift jet” venturi over pressure safety valve. The “50” of the ratio gear set then tandem to the input rotation of the “impeller” jet fan. The discharge pneumatic pressure from the unit then enters the coil return flow pipe. Additional flow pipe (air pressure) 49 to 44. the impeller a dual inlet gate valve to pull air from vacuum jet as well as the “re-directed” pressure flow from number 49. A dual stage impeller primary intake from vacuum jet flow second stage only when venturi pressure is at specified pressure range. The second stage acting as a flow cycle mechanical engine speed “regulator”.
45. Revolutions per minute sensor (R.P.M. sensor)—used to “regulate” the electric motors speed and input electricity level
46. High speed compressor temperature sensor
47. High speed compressor
48. Vacuum jet impeller drives the compressor fasted by argon velocity flow speed
49. “Lift jet” overpressure safety vent valve electric actuation sensor information/signal will auto adjust to slow system “lift jets” speed settings for safety
50. Small receiving sprocket (2.5″ dia.), drive air/vacuum producing pump
51. Electric clutch references pressure and/or vacuum pressure tanks levels for the zero-gravity generator to operate correctly
52. Air/vacuum producing pump
53. Dual shaft electric motor drive shaft connects to mid-size receiving sprocket (4″ dia.)
54. 1:10 ratio gear set driven by the electric motor and receiving sprocket to produce 10 times the rotation speed to the hydraulic fluid pump number 55
55. High volume hydraulic fluid pump-induces system speed advancement via the “hydraulic draft effect” of a pressurized fluid pressurizing a tilt to then harvest angular momentum as electricity while retaining the cyclical work potential as air pressure. Yielding sustained high voltage electricity production.
56. Hydraulic impeller-the impeller is caused to produce rotation connected to the Magneto (electricity generator voltage regulated) and main high voltage generator system internal speed limiter oil flow bypass valve for the structural integrity of the connecting flow pipes to remain within their operating parameters
57. High voltage generator
58. Permanent magnet magneto
59. Large, encased sprocket (12″ dia.), drive sprocket via the retained work potential pneumatic pressure within the fluid (hydraulic fluid oil tumbler number 65).
60. Generator system revolutions per minute (RPM) sensor-information/signal used to adjust the generator stable speed
61. Hydraulic fluid control valve-electric actuation valve contains system safety all stop function will prevent fluid lock
62. Generator system vacuum tank
63. Vacuum regulator valve with electric sensor to report actuation requirement/level/and temperature
64. Dual component oil and air pressure “oil tumbler” electric “spin up” electric motor
65. Dual component oil and air pressure “oil tumbler” pressure retaining pressure tank
66. Pneumatic pressure tank
67. Pneumatic control valve electric “start system” valve—vents air pressure into the vacuum tank to cause the dual component oil tumbler to rotate-required for zero gravity conditions
68. Pneumatic impeller causes the oil tumbler to rotate via connecting hard bolt connection system (all generator components are “end drive shaft bearing supported-sealed lubrication bearings with mounting housing for component stable placement)
69. Radiation resistant hull—may use exterior “insulated balloons” with electric heat resistors filled with carbon graphite granule causing a water ice slurry for impact resistance. Interior in hull water storage and pump system
70. Hinged impact safety shield PV (photovoltaic), “solar panel” (inner surface), connects to systems electrical storage battery assist in system, “re-boot” tertiary “re-boot” system functions sum of six panels upon the exterior surfaces upon the vessel end. PV panels produce electrical current when the vessel is aligned toward the Sun when impact shutters are positioned in the open position by electric hinge servo electric motors. The electrical charging system for the battery bank fed electricity from the solar panel also implements a piezoelectric solid-state unit with battery charging capacity and an additional back up piezoelectric unit for systems clocks/inductance cage shielded.
71. One way valve
72. “Gas jet” particle accelerator causes “return” inert noble gas to also cool as the speed is increased by “fluid stretching” the gas in increments like what an air conditioner does in the evaporation cycle.
73. Electrical and thermal insulation
74. Venturi overpressure safety valves
75. Gas jet venturis causes argon/refrigerant to increase flow speed and discharge pressure
76. Inert Nobel gas injector system sum of four in 360 degrees
77. Throttle “head unit” a particle accelerator that will produce thrust from discharge injection into linear flow of the flow cycle speed of the inert Nobel gas
78. Thermal cooling exchange system with electrical ground within letter “T” to “keep” the internal current “static electricity” within electrical load level for material selection service parameter. Unit encasement of non-electrically conductive material electrically insulated from the structural mounting points.
79. Control electronics “bay” servo robot service capacity
80. Oil tumbler through bore slip ring allows oil pressure discharge while maintaining pneumatic pressure
81. Ionization transmitter hydraulic piston system position control mechanics
82. 1:50 ratio gear set input rotation via vacuum jet impeller (sealed lubrication)
83. Landing foot hinge sum of four upon each quadrant
84. Pressure rated vacuum hatch/entry hatch locking
85. Refrigeration condenser
86. Refrigeration evaporator
87. Total hull embedded inductance “cage” prevents unwanted electric induction from disrupting sensitive electronics
88. Circumference electric motor for the system draft compressor-a brushless electric motor to also be able to be used as a brushless electricity generator to feed current to the internal coil particle accelerator
89. Internal “throttle speed head” gas intake unit
90. Six tube emitter “guides”
91. Pilot's slide up chair with environmental system for bio suit
92. Ration stow/water storage
93. Inertia counterweight—prevents unwanted static position aids in satellite's yaw pitch and roll due to the speed and rotation of the generator's rotating components acts like a gyroscope to stabilize the craft.
94. Free spin inducing armature drive automatic gear selection transmission output rotation advances the guide track that the main generator drive system rides upon.
95. Main generator drive mechanism fluid transfer “wheel balancer” aids in stable running and balanced rotation. The system contains fluid tank internal fluid transfer pumps and system sensors regarding “balanced” rotation and fluid level activated the fluid transfer pumps automatically by electronic circuit.
96. Main generator logic electronics logic and voltage regulation
97. “Free spin” inducing armature air flow impeller sum of 36 about 360 degrees
98. Main Generator frame air flow compressor rotates in tandem with the core drive unit FIG. 3—sum of 36 360 degrees.
99. Advancing wheel guide track motivated by rotational torque from number 94, then using high torque with low rotation output “to not” bark the wheels.
100. Air compressor drive drag wheel
101. Drag wheel (breaking reducing gearing and electric clutch)
102. Inertia flywheel (gyroscope stabilization a mass factor for total system)
103. Air compressor piston type system (electrical inductance de-energization system)
104. Air pressure discharge manifold with one-way valve connects to toroid pressure tank
105. Multi track thru bore electricity transfer slip ring
106. Toroid air pressure tank
107. Multi wire, ribbon wire power and information connection wire
108. Dual component pressure tank contains air pressure (Argon) and oil pressure to cause oil pressure discharge, air pressure causes oil pressure
109. High pressure oil pipe
110. magneto electricity generator
111. 1:4 ratio gear set high side output rotation tandem with number 114
112. Drive shaft rotates wheel number 113
113. Drive unit drive wheel
114. High speed hydraulic pump (induces the hydraulic fluid draft effect of a pressurized fluid)
115. System speed limiter bypass safety valve
116. Hydraulic fluid impeller rotates the input of the ratio gear set number 111.
117. Magneto drive hydraulic fluid impeller
118. Air pressure control valve vents only rated pressure level to number 108 with additional or increased air pressure vented to the internal cavitation of the sealed main generator to cycle out static electricity from the ionized cooling gas.
119. Core electric drive motor (inverse type) stationary core mounting.
120. Electric drive motor rotates gearset number 123.
121. Main drive wheel
122. Main drive wheel drive shaft
123. Seal lubrication gear set motivated by electric motor number 120
124. Main drive wheel pressure coil spring causes good surface contact pressure with the wheel track
125. Ionized air intake screen filter induction de-energization screen to dissipate the gas electrical charge
126. Air compressor drive shaft
127. Internal hemisphere refrigeration dome cap impact resistant
128. Refrigeration system refrigerant hose line
129. Refrigeration system condenser
130. Refrigeration pump/valve switch block/thermostat/lamp
131. Refrigeration system refrigerant hose line
132. Refrigeration system evaporator
133. Hydraulic fluid piston system—moves adjustable electromagnets
134. Hydraulic fluid hose
135. Hydraulic fluid piston
136. Solenoid actuated hydraulic fluid piston system
137. Solenoid system causes mechanical pressure to move electromagnets
138. solenoid connection lever physical contact with number 136 to move fluid pressure yielding the electromagnets motion
139. Variable intensity electromagnet
140. Gas drive access port/electronics “Bay”
141. Gas drive refrigeration system
142. Gas drive dome cap
143. Main Argon ion flow injector flow pipe
144. Speed head particle accelerator primary/main throttle head injector
145. Gas flow return cold Argon gas flow feed into electron injector
146. Electron emitter exhaust cold high speed ion flow
147. Venturi internal pressure sensor reports to logic mapping system
148. Over pressure thrust dampener acts to allow safe pressure to increase a “blow down safety depressurization an internal gas speed flow safety system
149. Internal blow down decompression pressure tank electrically insulated
150. Gas flow drive impeller rotates the center core shaft of the gear set whose rotational output then causes a high speed gas flow draft effect.
Label letter “A”=particle accelerator “ring” with wound electromagnet for magnetic shielding.
Label letter “B”=lift jet-carbon graphite laminate composite with epoxy-high compression capacity for “pressurization” (perpendicular and circumference layering), as a start pressure the pounds per square inch (PSI) range the “lift jet” then pressurized to ½ the weight of the total vehicle with an inert non electrically conductive Nobel gas such as Argon. Engine encased within a “shock casing” to protect from projectile and within an electrically grounded encasement. One way gas (Argon), fill valve upon the pipe coupling.
Label letter “C”=particle accelerator for the solar diffuser system transmitters
Label letter “D”=Sulfur Dioxide resonance destruction emitter
Label letter “E”=electron emitter sum of ten plus sum of ten intersect high
Label letter “F”=spherical positional internal “gas jet system”. Total system electrical grounding/safe to the touch thermal and electrical. Interior electrically/magnetically polarized surface repellant pole to prevent surface material etching by high-speed gas flow within the engine system. The venturi exhaust gate valves sum of two prevent “gas flow lock” whereas the “shutter valve”/throttle” is then the main valve to accelerate the gas flow discharge. This feature compensates for the compound vacuum electric jet suction preventing structural collapse of the main flow discharge chamber at velocity rate. A safety feature for structural integrity.
Label letter “G”=solar gain diffusion transmitter system
Label letter “H”=sensor bank communications and avionics system, camera, proximity altimeter (landing system)
Label letter “I”=positional electric motor driven servo with thru bore current transfer slip ring and position sensor with avionics link via electric wire contains bearing system (sealed lubrication)
Label letter “J”=gas jet bearing system
Label letter “K”=positional electric motor driven servo with thru bore current transfer slip ring and position sensor with avionics link via electric wire contains bearing system (sealed lubrication);
Label letter “L”=left;
Label letter “M”=core mounting system solid floor to roof pole.
Label letter “N”=north polarity electromagnet “solar flare safety system” able to guide the flow and safely dissipate . . . to prevent damage from solar flare in sequence shut off a magnetic pole to short the induction causes the flare to flip around.
Label letter “O”=bearing system (sealed lubrication)
Label letter “P”=“gas jet” refrigeration system “refrigeration bay”
Label letter “Q”=electric magneto an AC (alternating current), electricity generator also acting as a “drag break” to slow the compressor/impeller fans while producing more electricity by the increased electricity level fed to the field coil of the unit causing rotational speed to slow “break Baug”. This keeps the centrifugal elongation by rotation within the material selection service parameter.
Label letter “R”=right.
Label letter “S”=south magnetic pole
Label letter “T”=“gas jet” gas/refrigerant injector electric discharges angular to cause step propulsion emitting 360-degree angular 30 degree toward center line flow.
Label letter “U”=speed head particle accelerator able to within the unit can cause cyclical flow within itself to obtain extreme velocity causing high velocity discharge into center line flow yielding draft intake from return flow. The open center is a linear particle accelerator separate from the cyclical speed head particle coil within the same unit. The cyclical speed head is pressure regulated with redundant valve (mechanical and electrical) data.

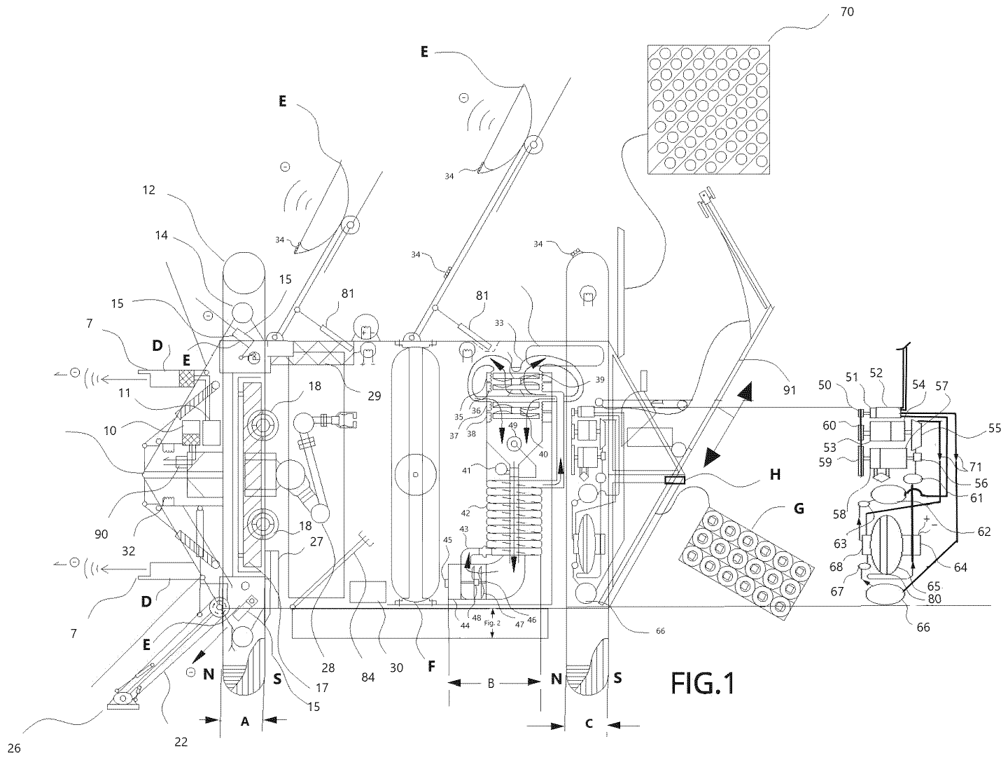

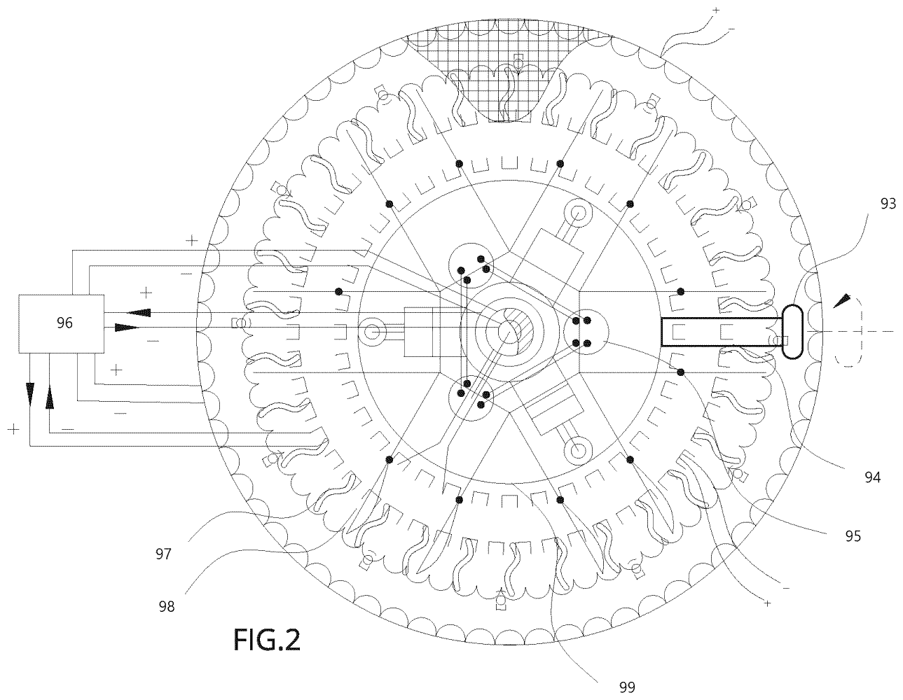

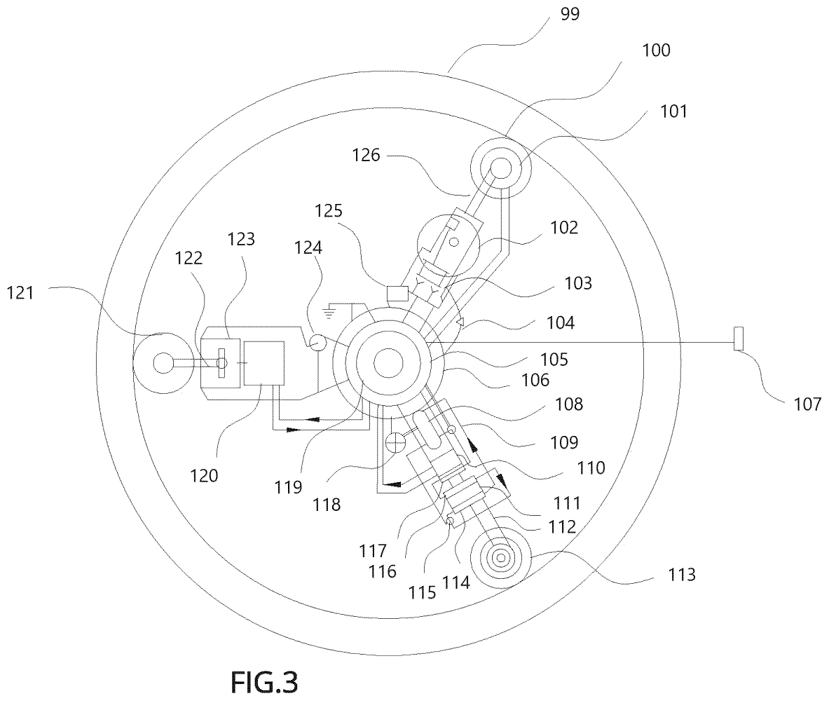

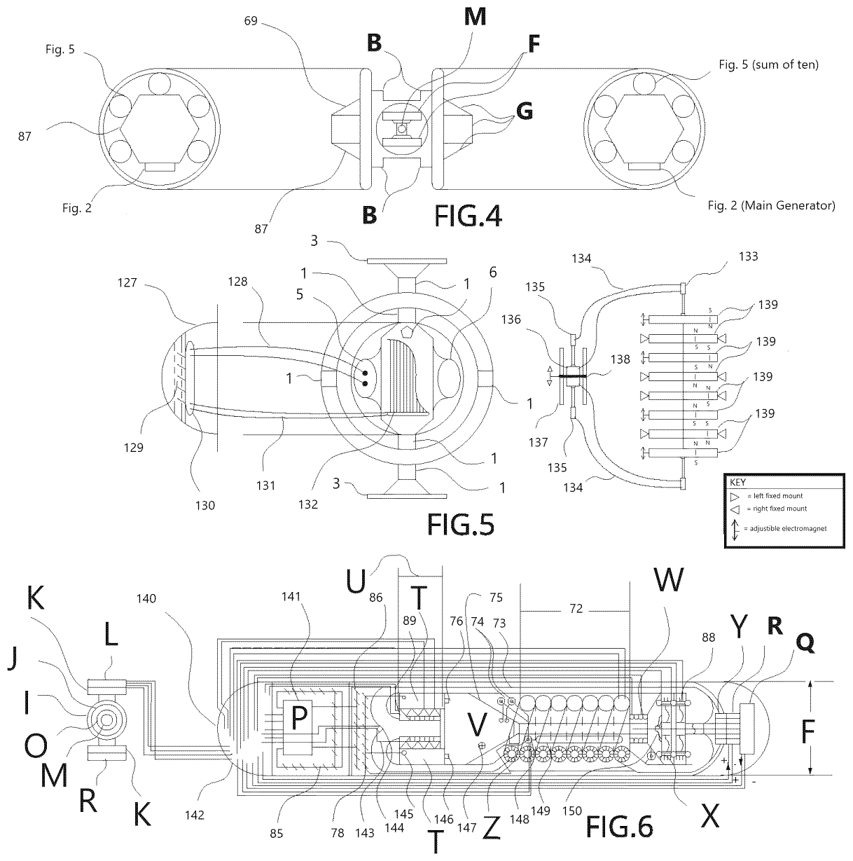

Referring now to FIG. 1, a diagram of an atmospheric repair satellite system is disclosed. The atmospheric repair satellite system is configured to transmit a resonance signal into the atmosphere of the planet Venus to cause vibratory separation of Carbon Dioxide while also dimming solar gain, thereby increasing thermal energy due to absorption of solar radiation. The system can ionize random carbon causing the formed magnetically tilted molecules “heavy” to then to “ash out” to the ground. The process can increase high altitude sulfur dioxide formed in the atmosphere of Venus, thereby reducing the total solar gain in the process. The free radical Oxygen molecule, created from Carbon Dioxide ionization, will naturally then form ozone via intersection with ultraviolet light. In a preferred embodiment, the design day side orbital distance can affect the total planetary hemisphere while in operation. The system can increase atmospheric lightning yielding “plasma destruction” and slight vitrification of the sulfur compounds while “ashing” out the carbon also sequestered within the vitrification composite. The vitrification composite, then a “heavy” molecule/compound, falls to the surface of the planet effectively “cleaning” the atmosphere. The atmospheric repair satellite system can also be used to control re-enter defunct satellites or clean space debris autonomously.

Referring now to the components of FIG. 1, the satellite can include an electric servo 1, which can serve as a “positional servo” with dual electricity transfer through bore current transfer slip ring with positional sensor. A force vectoring navigation system 2 utilizing a sealed oil jet which can include an oil jet flow system 4 for providing flow to the oil jet force vectoring system 2. A mounting system 3 for mounting the electric servo 1 with force vectoring system 2 to the satellite. Element 5 can be a high-pressure tank gravity spin dual component via electric motor which can contain a fluid transfer slip ring which can be useful for zero gravity start function. High-pressure tank 5 connects to oil jet flow system 4 via a flow pipe valve system for high pressure fluid. The high-pressure tank 6 can be a pneumatic pressure device configured to provide pressure to oil jet flow system 4 and can connect via pressure rated pipe with a control valve system. Alternatively, Element 5 can be an electromagnet levitation system to assist the sealed electric lift jets, letter “B” in breaking gravity during launch.

Referring now to chemical decomposition systems of FIG. 1. The chemical decomposition systems may include a Sulfur Dioxide resonance decomposition transmitter 7, which can transmit a pulsing vibration to wiggle apart the bond between Sulfur and the Oxygen molecule which can cause through the ionization process a “recombined compound” and can correct the “thermal retention” and Ph (acidic), properties of the Sulfur Dioxide. Element 10 can be Carbon Dioxide resonance decomposition transmitter arranged in a sum of six in 360 degrees left endpoint polar array, which can include a Carbon Dioxide resonance decomposition transmitter hinged lid 8 and a hydraulic piston assembly 9 that can open/close a shutter protecting the Carbon Dioxide resonance decomposition transmitter 10. The decomposition transmitter 10 can include a Carbon Dioxide resonance focus diffuser 32 to “spread” the diffused transmission wave to cover wide swaths of the atmosphere, preferably the total day side hemisphere. A six-tube emitter guide 90 can be provided as a part of diffuser 32.

The system includes a Sulfur Dioxide resonance transmitter 11 arranged in a sum of six in 360 degrees left endpoint polar array. A combined particle accelerator and electromagnetic toroid electromagnet vessel shielding system 12 can be attached to one or more oil jet mobile avionics trajectory vector units 18 which can be used to maintain orbital “static” while the vessel is in operation. In a preferred embodiment there can be four avionics trajectory units 18 mounted to the satellite using oil jet mounting system 19. In a preferred embodiment the vessel shielding system can be attached by a union mounting bolt plate assembly 13. The satellite can also include at least one electron emitter 15 which can be used to induce lightning within the atmosphere of Venus to cause lightning to induce “plasma destruction” to increase the sequestration of Sulfur by means of vitrification also then forming high level Ozone (O3) via the Ultraviolet light produced by the lightning itself. In a preferred embodiment, the electron emitter 15 can include six emitters arranged in angles summing to 360 degrees. Furthermore, electron emitter 15 can be attached to the system with an ionization transmitter hydraulic piston system 81 which can include position control mechanics. A particle accelerator electron emitter unit 27 can contain twelve electron injectors that can feed velocity to the electron emitters 15, to “sink” to low altitude to cause cloud-based lightning to arc to the surface of the ground of Venus, which can cause the surface to form an electrical ground. An inert Nobel gas, preferably Argon, filled ring pressure tanks 14 can be used to fill or de-pressurize the lift jets, which can be hard bolted to the hull of the satellite. The electron emitter can be controlled to change position via an electric motorized angular positional system 16 which contains a positional sensor and a connection linkage.

Referring now to the landing system of FIG. 1, the landing system can include landing gear hydraulic piston system 21 which can provide shock absorption to the system when landing. A landing gear leg beam 22 can include a landing gear foot positional hydraulic piston stabilizer 23 which can be connected to a landing gear foot positional hydraulic piston stabilizer 24. A landing gear pivot 25 can connect the leg beam 22 to a rubber landing gear foot tread and electromagnet 26 that hull contacts to a permanent magnet upon the hull's outer surface or can be used to stabilize and/or grab objects intended to re-enter. In a preferred embodiment, the landing foot hinge 83 can include four upon each quadrant. Sum of four total landing gear system.

Referring now to the robot arm of FIG. 1, the robot arm can contain an internal servo robot arm maintenance services system 28. The servo robot arm 28 can replace components, do minor system functions adjustments, and/or utilize an inter change grip, preferably a multi-tool, to use multiple tool that are stowed in multi-tool storage 29. A secondary avionics system 30 and a vessel hydraulic fluid pumping system 31 can be accessible to the server robot arm 28 housed in the same bay. It is noted that all electrical components of the system can be protected by and internal induction protection 17 for the system electronic control circuits temperature maintained including: chilling system contains circuit-controlled avionics/helm control-flight controls servo robot accessible, electrical relay system, circuit breaker system for vessel systems, which protects from induced current or radiation. The bay may include a pressure rated vacuum hatch/entry hatch 84 for access by a user also able to be used as a flight yolk.

A further aspect of the disclosed system of FIG. 1 can include an electron injection manifold unit 33, which can contain main pressure rated channels emitting loose electron into the particle accelerator prior to emission toward the Venusian atmosphere to induce lightning. When in high-speed transit a high-speed travel electromagnetic locking electromagnet 34 tilts a transmitter to lock the transmitter and sensor bank to monitor active function/infrared/optical camera/spectrometer about each surface so that the landing gear 22 can operate. A brushless generator transonic impeller 35 can cause negative “pressure” in the lower half of the lift jet engine system. The lift jet system can further comprise brushless electric motor “compressor” transonic jet fan 36, a high-speed brushless electric motor “compressor” transonic jet fan 37, a brushless generator transonic impeller 38 can cause increased mechanical speed in the compressor jet 37. Further aspects of the lift jet system can include a ratio gear system 39 sealed with chilled lubricant, preferably silicone oil, which can cause alignment to increase speed of the transonic impeller 35, and a ratio gear system 40 sealed with chilled lubricant, preferably silicone oil, which can cause alignment to increase speed of the transonic impeller 35. In a preferred embodiment, the gearing ration for systems 39 and 40 are 1:4. The lift jet system can include safety features including a lift jet overpressure safety vent valve 49 which can electrically actuate using sensor information/signal to auto adjust to slow system lift jets speed settings for safety.

Referring now to aspects of the fluid flow control and propulsion systems of FIG. 1, the control and propulsion system can include electric and hydraulic fluid actuated “lift jet” throttle valve unit 41 that can control the Argon flow speed exiting the system compression Venturi tube and a coil return tube 42, which can be a vacuum system effectuating low/negative pressure downstream of the Venturi tube which can return the gas at lower pressure to the thrust chamber providing constant discharge pressure into the vacuum, which can cause vessel lift via sealed flow system. A vacuum flow manifold 43 can be attached to the bottom of the return tube 42 which can be further connected to electric drive motor 44. The electric drive motor 44 can contain a mechanical drive pneumatic impeller for mechanical running with 1:50 ratio gear system 82 to advance the compression vacuum jet fan system in addition to the electric motor drive system. Air pressure (Nobel gas pressure) can be obtained from a safety regulator valve upon the “lift jet” venturi-effect over pressure safety valve. The discharge pneumatic pressure from the unit then enters a coil return tube 42. A vacuum jet impeller 48 can drive the compressor fasted by argon velocity flow speed. The impeller 48 can include a dual inlet gate valve to pull air from vacuum jet as well as re-directed pressure flow from 49. A dual stage impeller primary intake from vacuum jet flow second stage only activates when venturi pressure is at specified pressure range with the second stage acting as a flow cycle mechanical engine speed regulator.

Referring now to miscellaneous aspects of the fluid flow control and propulsion systems of FIG. 1, electric motor 44 and impeller system 48 can contain an R.P.M. sensor 45, which can be used to regulate the electric motors speed and input electricity level. The motor 44 and impeller 48 can also include a high-speed compressor 47, which can include a temperature sensor 46.

Referring now to aspects of air/vacuum pump 52 of the system of FIG. 1. Pump 52 can be installed on a receiving sprocket 50 which preferably has a diameter of 2.5 inches. Pump 52 will also produce hydraulic fluid pressure for other vessel functions that utilize hydraulic fluid pressure with valve control accessible by the pilot or done by the vessels on-board electronics such as landing gear deployment, emitter positioning and or emitter shutter open/close. Disposed between the sprocket 50 and the pump 52 is an electric clutch 51 which can reference pressure and/or vacuum pressure tanks levels for the zero-gravity generator to operate correctly. Below the pump 52 can be a dual shaft electric motor drive shaft 53 which can connect to mid-size receiving sprocket, which preferably has a diameter of 4 inches. The motor drive shaft 52 can be connected to a high-volume hydraulic fluid pump 55 which can induce system speed advancement via the “hydraulic draft effect” of a pressurized fluid pressurizing a tilt to then harvest angular momentum as electricity while retaining the cyclical work potential as air pressure. The drive shaft 53 can be connected to pump 55 via a 1:10 ratio gear set 54, which can be driven by the electric motor and receiving sprocket to produce 10 times the rotation speed to the hydraulic fluid pump number 55.

Referring now to a high voltage generator 57 of the system of FIG. 1, the high voltage generator 57 can be connected to a large, encased, sprocket 59, which is preferably 12 inches in diameter. The high voltage generator 57 can be further connected to a hydraulic impeller 56, which can produce rotation connected to a permanent magnet magneto 58 and the main high voltage generator 57 system, which can further include internal speed limiter oil flow by-pass valve for the structural integrity of the connecting flow pipes to remain within their operating parameters. The high voltage generator 57 and magneto 58 assembly can have the following safety sensors and systems installed: a generator system r.p.m. sensor 60 information/signal which can be used to adjust the generator stable speed; a hydraulic fluid control valve and electric actuation valve 61 which can contain system safety all-stop function to prevent fluid lock.

Referring now to a dual component oil and air pressure “oil tumbler” pressure retaining pressure tank 65 of the system of FIG. 1, the pressure tank 65 can include a dual component oil and air pressure “oil tumbler” electric “spin up” electric motor 64 and a pneumatic impeller 68 which can cause the oil tumbler to rotate via connecting hard bolt connection system. Furthermore, pressure tank 65 can include an oil tumbler through bore slip ring 80 which can allow oil pressure discharge while maintaining pneumatic pressure.

The impeller 68 can be connected to a generator system vacuum tank 62 via a vacuum regulator 63 valve with electric sensor to report actuation requirement, level, and temperature. A one-way valve 7 can be disposed between the vacuum tank 66 to prevent reversal of fluid flow. The impeller can be further connected to a pneumatic pressure tank 66 which can provide a reservoir for pneumatic fluid. A pneumatic control valve electric “start system” valve 67 can vent air pressure into the vacuum tank which can cause the dual component oil tumbler to rotate.

Referring now to the hull of the system of FIG. 1, a radiation resistant hull 69 may be constructed to use exterior “insulated balloons” with electric heat resistors filled with carbon graphite granule which can cause a water ice slurry for impact resistance. Furthermore, the hull can include a total hull embedded inductance “cage” 87 which can prevent unwanted electric induction from disrupting sensitive electronics. The interior of the hull can include a hull water storage and pump system.

Referring not to aspects of an electrical system of FIG. 1, a hinged impact safety shield photovoltaic solar panel 70, can connect to the systems electrical storage battery assist in system re-boot functionality. In a preferred embodiment, the solar panel system 70 includes six panels. Solar Panels 70 can produce electrical current when the vessel is aligned toward the Sun when impact shutters are positioned in the open position. The impact shutters are actuated open/closed by servo electric motors. The electrical charging system for the battery bank can feed electricity from the solar panel and can also implement a piezoelectric solid-state unit with battery charging capacity and an additional back up piezoelectric unit for systems clocks/inductance cage shielded.

Referring now to a gas jet system, Labeled F, of the system of FIG. 6. The gas jet system, F, can contain a “gas jet” particle accelerator 72 which can cause return inert noble gas to cool as the speed is increased by “fluid stretching” the gas in increments like what an air conditioner does in the evaporation cycle. The particle accelerator 72 can be covered by electrical and thermal insulation 73 and can include venturi overpressure safety valves 74. A gas jet venturi 75 can cause argon/refrigerant to increase in flow speed and discharge pressure, and inert Nobel gas injector system 76, which can be preferably configured as four units disposed in angles that sum to 360 degrees. Feeding into the gas injector system 76 can be an internal throttle speed head gas intake unit 89. The gas jet system, F, can include a throttle “head unit” a particle accelerator 77 that can produce thrust from discharge injection unto linear flow of the flow cycle run speed of the inert Nobel gas. A thermal cooling exchange system 78 with electrical ground within letter “T” to keep the internal current static electricity within electrical load level for material selection service parameter can be disposed within the system, F. The system, F, can include a refrigeration condenser 85 and a refrigeration evaporator 86. Finally, a circumference electric motor 88 can be provided for the system draft compressor, which can be a brushless electric motor to also be able to be used as a brushless electricity generator to feed current to the internal coil particle accelerator.

Furthermore, unit encasement of non-electrically conductive material can be provided which can electrically insulated from the structural mounting points. The gas jet system, F, can also include a control electronics “bay” servo robot service capacity 79 which can provide for a robot to make repairs to the system, F.

Further aspects of the inventive system of FIG. 1 are listed below: “A” is a particle accelerator “ring” with wound electromagnet for magnetic shielding; “B” is a lift jet-carbon graphite laminate composite with epoxy-high compression capacity for “pressurization” (perpendicular and circumference layering), as a start pressure the pounds per square inch (p.s.i.) range the “lift jet” then pressurized to 1/2 the weight of the total vehicle with an inert non electrically conductive Nobel gas such as Argon. The engine can be encased within a “shock casing” to protect from projectile and within an electrically grounded encasement. One way gas (Argon), fill valve upon the pipe coupling; “C” is a particle accelerator for the solar diffuser system transmitters; “D” is a Sulfur Dioxide resonance destruction emitter; “E” is an electron emitter; “F” is a spherical positional internal “gas jet system”; “G” is a solar gain diffusion transmitter system; “H” is a sensor bank communications and avionics system, camera, and proximity altimeter for a landing system; “I” is a positional electric motor driven servo with thru bore current transfer slip ring and position sensor with avionics link via electric wire contains bearing system; “J” is a gas jet bearing system; “K” is a positional electric motor driven servo with thru bore current transfer slip ring and position sensor with avionics link via electric wire contains bearing system; “L” a left direction indicator; “M” is a core mounting system solid floor to roof pole; “N” is a north polarity electromagnet “solar flare safety system” able to guide the flow and safely dissipate and can prevent damage from solar flare in sequence shut off a magnetic pole to short the induction causes the flare to flip around; “O” is a bearing system; “P” is a gas jet refrigeration system refrigeration bay; “Q” is an electric magneto generating alternating current, and can also act as a “drag break” to slow the compressor/impeller fans while producing more electricity by the increased electricity level fed to the field coil of the unit causing rotational speed to slow “break baug”. This can keep the centrifugal elongation by rotation within the material selection service parameter; “R” is a right direction indicator; “S” is a south magnetic pole; “T” is a gas jet gas/refrigerant injector electric which discharges angularly to cause step propulsion emitting 360 degree angular 30 degree toward center line flow; “U” is a speed head particle accelerator able to cause cyclical flow within itself to obtain extreme velocity causing high velocity discharge unto center line flow yielding draft intake from return flow. The open center is a linear particle accelerator separate from the cyclical speed head particle coil within the same unit. The cyclical speed head is pressure regulated with redundant valve (mechanical and electrical), with information sensor reporting actuation level. The speed head then discharges unto the center line gas flow using magnetic field dampener valve; “V” is a venturi flow compressor; “W” is a flare flow diffuser electromagnetic spread which decompresses the gas flow by a spreading effect; “X” is a drive “input impeller” with thru center flow channel and can also be a brushless electric motor. A brushless electric motor is also able to be used as a brushless electricity generator to feed current to the internal coil particle accelerator; “Y” is a center input shaft gear system (automatic gear selection transmission) outer shaft then with greater rotational speed 1:150. The 150 of the ratios then tandem with the transonic fan number 88. Center shaft tandem with the unit's dual shaft brushless electric motor whose opposite side output shaft is then tandem rotating with letter “Q”. The unit's electric motor then contains an RPM sensor, enabled to set the system vacuum throttle, wherein “Z” is a throttle system gate and shutter valve.

The subject disclosure may include a hydraulic draft generator system within the vessel may also use battery electricity to assist in startup via electrification of system drive electric motor, number 53. The label letter “F” is then a depiction of the “gas drive” system. The component then requires an in-depth description to assist in comprehension of its function. Due to the nature of the “gas drive” system . . . electricity produced from the flow cycle will need to be controlled as moving “fluid”/gas then produces static electricity. The static electricity is harvested in letter “T” and directed to the electrical control unit number 79. The electrical current level then conditioned (voltage regulated/and overload protected—waste current level dissipation injection speed discharge valve position refrigerant flow speed/cold side refrigeration cycle speed) and directed to the master electronic/electricity management system within number 79, to “electrify” the internal refrigeration system. Letter “T” connecting coupling from the system thermal/cooling exchange system then is also an external port (one way valve with pressure level gauge), to “fill” the “gas jet” with the required gas pressure/refrigerant level. Any excess electrical current that the design produces then is routed through the positional servo via thru bore electricity transfer slip rings and directed to the vessel master power block number 30 where it (electricity) is directed to other vessel functions. The “gas jet” speed head then a particle accelerator that can also use the static electricity harvest to cause cyclical (unto itself) internal speed advancement . . . producing an increased speed of the inert Nobel gas within the unit. This allows for a “thrust” capacity to discharge as a “throttle” system increasing the speed of internal main line thrust flow until the venturi regulation over pressure sensors causes internal flow cycle speed limit, factoring venturi pressure level as a critical safety fault within the system. Letter “T's” system then contains a “run” speed flow cycle vent exhaust pressure dampener valve “set at discharge pressure level” while number 74 is feeding gas pressure to the cooling exchangers. Number 74's “return” flow cycle then implements a pressure tank acting as a pressure “volume” sink (volume retainer), required for the “speed pressure rate” to be maintained when accelerating the system with increase of the cold injectors, letter “T” The discharge pressure valve of letter “T” will also be assisted by maximum pressure safety valve that vents a “run speed” level (base idle speed) i.e., also containing an information sensor to act as “level of actuation” of the valve to then communicate with avionics main logic “mapping electronics” to “govern” system function. Vents unit “overpressure” into the Venturi with the main valve open or closed. Collected information then reduces and extrapolates information via electronic circuit to determine gas flow cycle speed producing a close estimate of velocity rate effect for the vessel's avionics information also displayed upon video screen placed above servo robot base rotation servo with mechanical meter display (secondary avionics). The electromagnets within the “return cycle” flow cycle use metal wire windings as the electrically conductive synthetic fiber has a thermal problem at required run rates. . . . The aft “decompression chamber in letter “F” then implements an over pressure safety valve that may be end point polar arrayed to then be in greater number i.e., the sum of 12 about 360 degrees to allow for greater chamber decompression. This becomes required to not encumber the flow speed within the “gas jet” engine design. https://www.designdeskinc.com/venus-atmospheric-repair-satellite.html.

The particle accelerator system contemplated by the subject disclosure is configured to accelerate electron derived from free energy using the pneumatically pressurized draft of a rotating hydraulic fluid to then off set mechanical resistance while harvesting angular momentum converting it to electrical energy as electricity. The particle accelerator system will also feed electron at high velocity to the solar gain diffusion transmitter/watt per square meter reduction transmitter (also transmitting loose electron), and to the ionization transmitter system (also transmitting loose electron). Ground communications when in use uses a radio relay communications system due to the vessels placement i.e., the day side of Venus. The electron emission from both emitter systems then of “tight/narrow” diameter to induce electrical charge within the atmosphere causing lightning, while the “carrier wave”/i.e., “the resonance decomposition “signal” a wider diameter. The ring particle accelerators are connected “so that”, the bank of 12 electron injectors, number 27, feed electron to both particle accelerators letter “A” and letter “C”. The particle accelerators may work linked or at differentiated speeds to increase total velocity of the emitted electron. The inert Nobel gas (Argon), pressurized sealed electric pneumatic lift jet then like a mechanical balloon cycling high pressure to then discharge the force vectoring capacity into mechanically produced vacuum, causing sealed lift. The bank of two electric gas jet is mounted upon rotator carriage (spherical positional system), to then change the flight vector also assisted by multiple compounds sealed fluid rhomboid fluid propulsion to assist in flight gimbal vector in a spherical fashion (mobile mounting spherical positional system). The gas jet system forces vector displacement angles adjust by rotating in tandem or independently to cause vessel roll. Avionics fault safety to prevent overstress of the mechanical properties of the vessel i.e., vessel speed dynamics limit trajectory correction (gas jet displacement), for systems safety. The oil jet system then used also to slowly slow high-speed travel . . . as a retro trajectory function. The solar gain reduction transmitter then does not in advertently affect (gauss) the asteroid belt or magnetize asteroids in the solar system disk plane. The resonance transmitter causes the bond between the carbon and oxygen molecules to vibrate apart yielding re-combinate sulfur compounds and atmospheric ozone. The ionized carbon will bond with the atmospheric sulfur compounds that are also present in the atmosphere. Carbon Monoxide will also form but can be cycled out after duration of system function. Atmospheric Nitrogen can be mechanically liberated from rock to increase the stability of the atmosphere over time or as an option the resonance system might be able to convert Carbon and Hydrogen to Nitrogen ion yielding Nitrogen.Hull composite material selection then of metalized plastic whereas the dipped plastic is then coated with a metalized material that will allow for the thermal conductivity acting as an electric resistor to keep the plastic within service operating parameters. This reduces vehicle weight and embrittlement. The electromagnetics then are also of alternative material using an electrically conductive synthetic fiber to reduce weight. The scale of the total system is 20%-30% larger than a modern golf cart to allow for the power delivery vs. weight of mechanism to operate correctly. Metal may be used in vehicle hull construction or only where required in components where service parameter demand it. Electricity management control systems, Avionics, satellites “mapping” systems control i.e., transmitters receivers/electron emitters Internal H.V.A.C. craft induction dissipation to control induced electrical gain, and craft sensor systems for monitoring crafts functions are all contemplated by the subject disclosure.

Resonance decomposition of Venus atmosphere to convert the high temperature into was and vitrified sulfur compound to drop the planet's temperature and cause a water ocean that can be converted from high acidity to usable water providing the magnetic field can be restored or mechanically augmented by satellites.

Additionally, the subject disclosure embodies solar flare diffusion through solar flare redirection via an analogous solar diffuser transmitter system. Also, a byproduct of the subject disclosure is the creation of water.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the subject disclosure and that modifications may be made without departing from the spirit and scope of the subject disclosure as set forth in the following claims.

What is claimed is:

1. A satellite system for reducing planetary warming through solar gain mitigation, comprising:
a platform configured to support the system components;
a transmitted resonance subsystem comprising a plurality of carbon dioxide resonance decomposition transmitters and a plurality of sulfur dioxide resonance transmitters arranged in a polar array, the transmitted resonance subsystem configured to decouple carbon dioxide and sulfur dioxide through vibratory separation and transmitted resonance;
an atmospheric ionization subsystem comprising at least one electron emitter arranged about 360° and configured to ionize atmospheric constituents and induce lightning to cause plasma destruction that vitrifies sulfur compounds while sequestering carbon;
a positioning subsystem configured to place the satellite in a high day-side Venusian orbit to induce hemisphere ionization and facilitate vibratory separation of thermal retaining atmospheric constituents; and
a control subsystem operatively connected to the transmitted resonance subsystem, the atmospheric ionization subsystem, and the positioning subsystem, the control subsystem configured to coordinate operation of the system components to reduce solar gain and thereby mitigate planetary warming.

2. The satellite system of claim 1, wherein the platform comprises solar panels configured to provide electrical power to the system components.

3. The satellite system of claim 1, wherein the transmitted resonance subsystem further comprises a hinged lid for protecting the carbon dioxide resonance decomposition transmitters.

4. The satellite system of claim 1, wherein the atmospheric ionization subsystem comprises a plurality of electron emitters arranged in a ring configuration about the platform.

5. The satellite system of claim 1, wherein the positioning subsystem further comprises a propulsion unit configured to maintain and adjust the satellite in the high day-side Venusian orbit.

6. The satellite system of claim 1, wherein the control subsystem further comprises a communication module configured to transmit telemetry data regarding system performance.

7. The satellite system of claim 1, wherein the transmitted resonance subsystem is configured to transmit pulsed resonance signals to induce vibratory separation of carbon dioxide and sulfur dioxide.

8. The satellite system of claim 1, wherein the atmospheric ionization subsystem is further configured to generate electrical discharges to induce lightning for plasma destruction that vitrifies sulfur compounds.

9. The satellite system of claim 1, wherein the platform comprises a radiation-resistant hull constructed from materials configured to mitigate environmental damage.

10. The satellite system of claim 1, wherein the control subsystem is programmed to coordinate periodic calibration and synchronization of the transmitted resonance subsystem and the atmospheric ionization subsystem.

11. A method for reducing planetary warming through solar gain mitigation, comprising:
positioning a satellite in a high day-side Venusian orbit configured to induce hemisphere ionization;
transmitting pulsed resonance signals from a polar array of carbon dioxide resonance decomposition transmitters and sulfur dioxide resonance transmitters arranged about the satellite to decouple carbon dioxide and sulfur dioxide through vibratory separation;
ionizing the atmosphere by activating electron emitters arranged about 360° to induce lightning that causes plasma destruction wherein the induced lightning vitrifies sulfur compounds and sequesters carbon; and
coordinating the positioning, transmission, and ionization steps via a control subsystem to reduce solar gain and thereby mitigate planetary warming.

12. The method of claim 11, wherein the periodic calibration comprises automatically initiating a diagnostic routine to verify the operational status of the carbon dioxide resonance decomposition transmitters and the sulfur dioxide resonance transmitters.

13. The method of claim 11, further comprising configuring a user interface to allow manual override and adjustment of the calibration and synchronization parameters of the transmitted resonance subsystem and the atmospheric ionization subsystem.

14. The method of claim 11, wherein the periodic calibration further comprises adjusting the transmission power levels of the pulsed resonance signals based on telemetry data received from the communication module.

15. The method of claim 11, wherein the synchronization of the transmitted resonance subsystem and the atmospheric ionization subsystem includes coordinating the timing of the electron emitter activation with the initiation of the pulsed resonance signals to optimize vibratory separation.

16. The method of claim 11, wherein the control subsystem comprises a processor configured to execute software instructions stored on a non-transitory computer-readable medium for performing the periodic calibration and synchronization of the transmitted resonance subsystem and the atmospheric ionization subsystem.
